(19) United States
(12) Patent Application Publication
(10) Pub. No.: US 2020/0304875 A1
(43) Pub. Date: Sep. 24, 2020

(54) USER INTERFACE FOR INTRUSION SECURITY PANEL THROUGH STREAMING DEVICE

(71) Applicant: CARRIER CORPORATION, Palm Beach Gardens, FL (US)

(72) Inventors: Anantha Krishnan, Hyderabad (IN); Ramesh Babu, Hyderabad (IN); Sunil Kumar Neckaraje, Hyderabad (IN); Michael Ramoutar, Westford, MA (US)

(73) Assignee: CARRIER CORPORATION, Palm Beach Gardens, FL (US)

(21) Appl. No.: 16/086,118

(22) PCT Filed: Mar. 9, 2017
(86) PCT No.: PCT/US2017/021495

§ 371 Date: Sep. 18, 2018

Related U.S. Application Data
(60) Provisional application No. 62/310,950, filed on Mar. 21, 2016.

(51) Int. Cl. H04N 21/478

(52) U.S. Cl. CPC H04N 21/478

(57) ABSTRACT

A security system includes a sensor suite in communication with the security panel and a streaming device in communication with the security panel, the streaming device operable as an interface to control the security system.

### BACKGROUND

The present disclosure relates to a security system and, more particularly, to a security system that utilizes a streaming device such as a smart television for notification and control.

Intrusion security panels are electronic control devices that are primarily used to supervise residence and office premises to report access events to a user and/or monitoring stations. Intrusion security panels usually utilize a human machine interface (HMI) such as a keypad and LCD display, touchscreen display and/or, smartphone apps. The mounted interfaces may require close proximity to view and control; whereas smartphones are battery operated and may possibly be engaged in a variety of other activities which may leave the user with no alternate option for accessing the security panel unless current smartphone activity is discontinued.

### SUMMARY

A security system, according to another disclosed non-limiting embodiment of the present disclosure can include a security panel; a sensor suite in communication with the security panel; and a streaming device in communication with the security panel, the streaming device operable as an interface to control the security system.

A further embodiment of the present disclosure may include, wherein the security panel is a fixture.

A further embodiment of the present disclosure may include, wherein the streaming device is a television.

A further embodiment of the present disclosure may include, wherein the sensor suite is associated with home automation.

A further embodiment of the present disclosure may include, wherein the sensor suite includes a security sensor.

A further embodiment of the present disclosure may include, wherein the sensor suite includes a sensor associated with house lighting.

A further embodiment of the present disclosure may include, wherein the sensor suite includes a sensor associated with a thermostat.

A security system according to another disclosed non-limiting embodiment of the present disclosure can include a conversion device; a sensor suite in communication with the conversion device; and a streaming device in communication with the sensor suite via the conversion device, the streaming device operable as an interface to control the security system.

A further embodiment of the present disclosure may include, wherein the security panel is a fixture.

A further embodiment of the present disclosure may include, wherein the streaming device is a television.

A further embodiment of the present disclosure may include, wherein the conversion device includes a USB interface.

A further embodiment of the present disclosure may include, wherein the sensor suite includes a security sensor.

A further embodiment of the present disclosure may include 8, wherein the sensor suite includes a sensor associated with house lighting.

A further embodiment of the present disclosure may include, wherein the sensor suite includes a sensor associated with a thermostat.

A method of operating a security system, the method according to another disclosed non-limiting embodiment of the present disclosure can include utilizing a streaming device as an interface to control a security system.

A further embodiment of the present disclosure may include, wherein the streaming device communicates with a sensor suite through a security panel.

A further embodiment of the present disclosure may include, wherein the streaming device communicates with a sensor suite through a conversion device.

A further embodiment of the present disclosure may include plugging the conversion device into the streaming device.

A further embodiment of the present disclosure may include, wherein the streaming device is a television.

A further embodiment of the present disclosure may include, wherein the streaming device is a television.

The foregoing features and elements may be combined in various combinations without exclusivity, unless expressly indicated otherwise. These features and elements as well as the operation thereof will become more apparent in light of the following description and the accompanying drawings. It should be appreciated; however, the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic view of a security system according to one disclosed non-limiting embodiment;

FIG. 2 is a block diagram of the security system;

FIG. 3 is a schematic view of a security system according one disclosed non-limiting embodiment; and

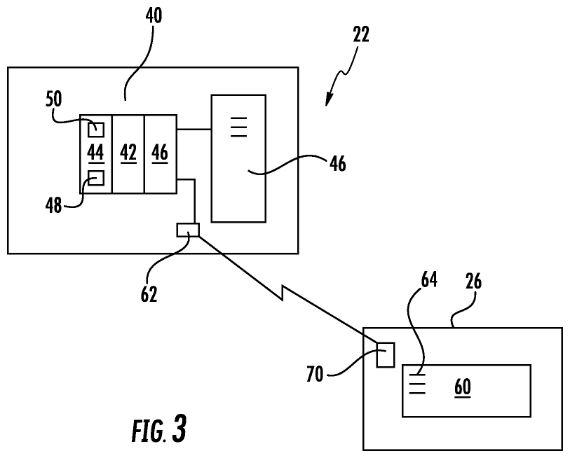

FIG. 4 is a schematic view of a security system according another disclosed non-limiting embodiment.

### DETAILED DESCRIPTION

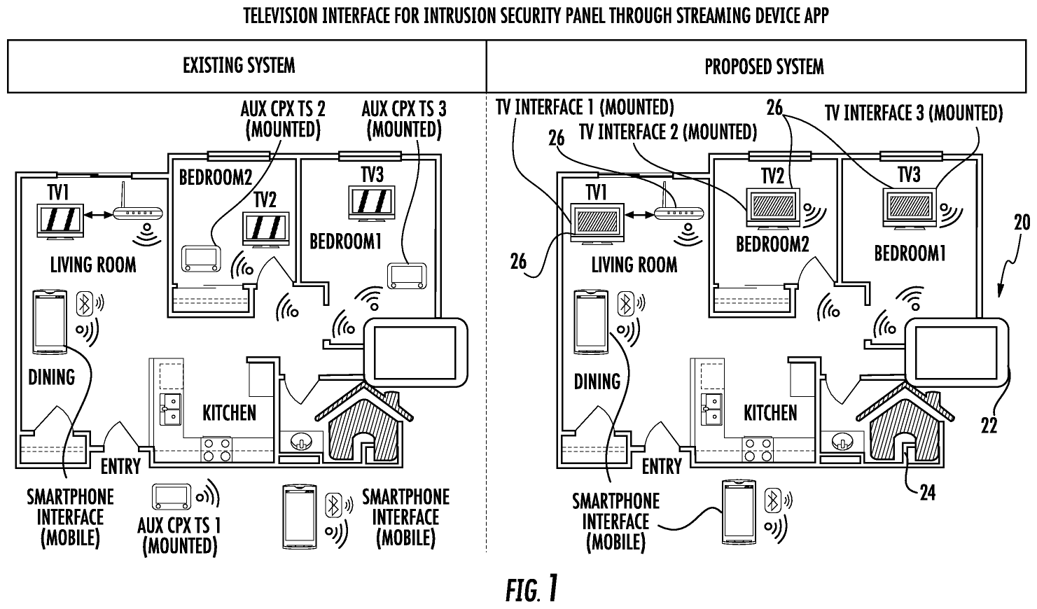

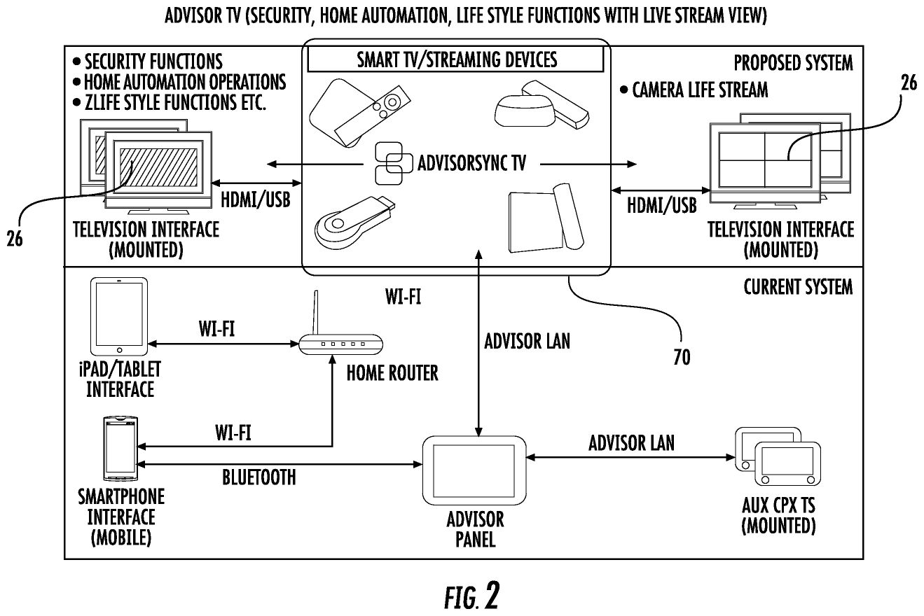

FIG. 1 schematically illustrates a security system 20. The security system 20 generally includes a security panel 22, a sensor suite 24 in communication with the security panel 22, and one or more streaming devices 26, e.g. a smart Television, TV Streaming device, an internet router, etc. (FIG. 2). It should be appreciated that the security panel 22 may be a security panel or form a portion thereof. It should be still further appreciated that although particular systems are separately defined, each or any of the systems may be otherwise combined or separated via hardware and/or software. The communication may be conveyed to one or more networks. For example, the communication may be transmitted to the Internet and/or a cellular network. The network(s) may include infrastructure that may be organized to facilitate cloud computing.

With reference to FIG. 2, the security panel 22 generally includes a control module 40 with a processor 42, a memory 44, and an interface 46. The processor 42 may be any type of microprocessor having desired performance characteristics. The memory 44 may include any type of computer readable medium that stores the data and executable instructions 48 described herein below. The executable instructions may be stored or organized in any manner and at any level of abstraction, such as in connection with one or more applications 48, processes, routines, procedures, methods, etc. The memory 44 may also store data 50 that, for example, includes an access code validation engine, a device identifier, or any other type of data. The access code validation engine is the authorization code that disables sensors 30 reporting to the security panel 22 to disarm the security system 20. The processor 42 may execute the instructions stored in the memory 44 that are operative on the data 50. The processor 42 may be coupled to the interface 46 that may include one or more of a keyboard or keypad, a touchscreen or touch panel, a display screen, a microphone, a speaker, etc. The interface 46 may also support a graphical user interface (GUI) and/or voice-to-text capabilities to operate the system.

In one disclosed non-limiting embodiment, the user can remotely access an interface 60 on the streaming device 26 that provides system operability similar to the interface 46. The control module 40 of the security panel 22 may include a communications module 62 that is operable to connect with an Interface 70 and communicate with the streaming device 26. The security panel 22 often communicates on a less than 1 GHZ unlicensed band such as 319.5, 433, or 868 MHZ such that the control module 40 may be operable to convert the communication to that typically operable with the streaming device 26 such as the Smart TV, TV Streaming devices (like Apple TV, Chromecast, Roku etc.) That is, applications 69 on the streaming device 26 may be utilized to securely exchange security panel protocol between the streaming device 26 and the control module 40 to present a rich graphical user interface to view and control security features, life style functions (home automation, lights thermostats, outdoor camera live streams, etc.) and other security panel 22 functionalities. Existing remote controls of the Smart TV/TV Streaming device can be used for easy navigation between different screens and features on the app.

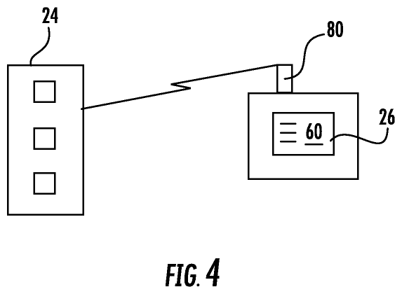

With reference to FIG. 4, in another disclosed non-limiting embodiment, a conversion device 80 may be plugged directly into the streaming device 26 such as via a USB port to permit the sensor suite 24 to have direct communication with the streaming device 26. That is, the streaming device 26 itself operates as the security panel interface 26 to the sensor suite 24 via the conversion device 70.

In another disclosed non-limiting embodiment, smartphone apps may be provided for smart television and streaming devices which could use the network and display capabilities of the television to provide a rich user interface to the control panel. Also like any other streaming devices such as Apple TV, Amazon Fire, etc., a dedicated security panel streaming device, for instance AdvisorTV similar to AppleTV, can be plugged into the television to stream content on a television. Also, these streaming devices could be configured as a client to the control panel and video streaming of the cameras can be viewed on the apps on the streaming devices. Further, these streaming devices could be configured as a Wi-Fi client to the control panel and video streaming of the cameras can be viewed on the apps on the streaming devices.

Usage of the streaming device 26 as an intrusion security panel provides an efficient graphical user interface such that users can view and control the security status, home automation, live stream of cameras sitting comfortably in the living, bedroom and other locations on a relatively large display. That is, the necessity for auxiliary displays can be reduced by utilizing the most used and available electronic device typically present in a home. This idea can be utilized to make TV as a primary user interface for display less, touchscreen less control panels and can bring cost benefits to the user and the company. This streaming device 26 can also be extended to legacy panels which were operated by alpha numeric displays to have a richer user interface on television.

The elements disclosed and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, dynamically loaded or updated modules, or any combination of these, and all such implementations may be within the scope of the present disclosure.

It should be appreciated that like reference numerals identify corresponding or similar elements throughout the several drawings. It should also be appreciated that although a particular component arrangement is disclosed in the illustrated embodiment, other arrangements will benefit herefrom.

Although the different non-limiting embodiments have specific illustrated components, the embodiments are not limited to those particular combinations. It is possible to use some of the components or features from any of the non-limiting embodiments in combination with features or components from any of the other non-limiting embodiments.

Although particular step sequences are shown, disclosed, and claimed, it should be appreciated that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically disclosed. For that reason the appended claims should be studied to determine true scope and content.

What is claimed is:

1. A security system, comprising:
a security panel;
a sensor suite in communication with the security panel; and
a streaming device in communication with the security panel, the streaming device operable as an interface to control the security system.

2. The system as recited in claim 1, wherein the security panel is a fixture.

3. The system as recited in claim 1, wherein the streaming device is a television.

4. The system as recited in claim 1, wherein the sensor suite is associated with home automation.

5. The system as recited in claim 1, wherein the sensor suite includes a security sensor.

6. The system as recited in claim 1, wherein the sensor suite includes a sensor associated with house lighting.

7. The system as recited in claim 1, wherein the sensor suite includes a sensor associated with a thermostat.

8. A security system, comprising:
a conversion device;
a sensor suite in communication with the conversion device; and
a streaming device in communication with the sensor suite via the conversion device, the streaming device operable as an interface to control the security system.

9. The system as recited in claim 8, wherein the security panel is a fixture.

10. The system as recited in claim 8, wherein the streaming device is a television.

11. The system as recited in claim 8, wherein the conversion device includes a USB interface.

12. The system as recited in claim 8, wherein the sensor suite includes a security sensor.

13. The system as recited in claim 8, wherein the sensor suite includes a sensor associated with house lighting.

14. The system as recited in claim 8, wherein the sensor suite includes a sensor associated with a thermostat.

15. A method of operating a security system, the method comprising:
utilizing a streaming device as an interface to control a security system.

16. The method as recited in claim 15, wherein the streaming device communicates with a sensor suite through a security panel.

17. The method as recited in claim 15, wherein the streaming device communicates with a sensor suite through a conversion device.

18. The method as recited in claim 17, further comprising plugging the conversion device into the streaming device.

19. The method as recited in claim 15, wherein the streaming device is a television.

20. The method as recited in claim 15, wherein the streaming device is a television.
